(19) United States
(12) Patent Application Publication
(10) Pub. No.: US 2003/0014309 A1
(43) Pub. Date: Jan. 16, 2003

(54) Method for judging unauthorized use of point information and promotion system

(76) Inventors: Michihiro Ota, Saitama (JP); Hiroaki Yoshida, Saitama (JP); Hiroaki Shinada, Saitama (JP)

Correspondence Address: Welsh & Katz, 22nd Floor, 120 South Riverside Plaza, Chicago, IL, 60606-3913, US

(21) Appl. No.: 10/169,627

(22) PCT Filed: Oct. 30, 2001
(86) PCT No.: PCT/JP01/09526

(30) Foreign Application Priority Data
Nov. 6, 2000 (JP) 2000-337758

(51) Int. Cl. G06F 17/60

(52) U.S. Cl. 705/14

(57) ABSTRACT

A method for judging unauthorized use of point information and a promotion system, which realize effective use of a point issue number added to the point information. Of the used point numbers, only the numbers contained in a predetermined range are stored. If the point issue number of the point information sent from the user lies in the predetermined range, whether or not it has been used is confirmed by comparing it with the used point issue number stored.

### TECHNICAL FIELD

The present invention relates to a method for judging unauthorized use of point information of a promotion system for sales promotion of commodities by issuing points when the commodities are sold.

### BACKGROUND ART

Conventional promotion or the like of a particular commodity involves issue of points every time the commodity is sold, and the buyer of the commodity collects points and exchanges the points with a free gift or the like.

Here, such points are issued by a mode of stamping a seal or magnetic recording on a card possessed by each user or a mode of applying a seal or the like to commodities in such a way that buyers collect such a seal.

But, the mode of applying a seal or the like to commodities to issue points requires both a seller and buyers a lot of trouble in handling such points. The mode of adding points to the card possessed by each buyer is particularly hard to issue points by an automatic vending machine, and it is also difficult to comply with nation-wide promotion sponsored by the manufacturer of commodities.

In any case, a lot of trouble is needed for recovery and totalization of points by the sponsor of promotion.

To remedy such problems, the inventors have proposed in Japanese Patent Applications No. 11-280034 and No. 2000-210217 a promotion system that, when a commodity is sold, point information about encrypted points is shown to the buyer, the buyer simply sends the shown point information to a center apparatus by communications equipment such as a portable telephone, a personal computer or the like, the center apparatus decodes the point information and adds the points, and the seller provides a service corresponding to the accumulated points.

Here, in the above promotion system, as a process to prevent the same point information from being sent a plurality of times because of carelessness or malice of the user, the center apparatus judges the double use of the point information according to whether the point issue number of the accepted point information matches a point issue number of the already accepted point information, and when the point issue number of the accepted point information is quite different from the point issue number of the point information previously accepted as genuine, the point information is judged that it has a possibility of unauthorized use.

According to the above method, however, the point issue number which is already accepted by the center apparatus can not be used again, so that the number of times the points are issued is limited by the maximum value of the point issue number.

### DISCLOSURE OF THE INVENTION

Accordingly, it is an object of the present invention to provide a method for judging double use and unauthorized use of point information with reliability without limiting the number of times the points are issued to the maximum value of the point issue number.

To achieve the above object, the method for judging unauthorized use of points according to the invention is a method for judging unauthorized use of points of a promotion system in which point information related to a prescribed point is issued and shown to a user when a commodity is sold, the user sends the shown point information together with identification information of the user to a center apparatus, the center apparatus stores and manages points corresponding to the sent point information in correspondence with the user, and a prescribed service is provided to the user according to the points stored and managed in correspondence with the user, wherein a point issue number which indicates the order of issue of the point information is added to the point information shown to the user; the center apparatus stores the point issue number of the latest point information among the point information accepted as genuine by the last time and stores whether the point issue numbers contained in a prescribed range having the point issue number of the stored latest point information at the center have been used or not by the last time, and the point issue number sent from the user is accepted as genuine when the point issue number of the point information sent from the user does not match the point issue number which is contained in the prescribed range and stored as a used one by the last time.

The point issue number recurs and is reused from 1 when it reaches the maximum value.

The latest point information is point information which is the latest in order of issue or the latest in order of acceptance by the center apparatus.

When the point issue number of the stored latest point information is updated, the prescribed range is updated accordingly, and when the point issue number stored as a used one by the last time falls outside the prescribed range because of the update of the prescribed range, memory about the point issue number that it has been used by the last time is deleted.

Besides, the method for judging unauthorized use of points according to the invention is a method for judging unauthorized use of point information of a promotion system in which point information related to a prescribed point is issued and shown to a user when a commodity is sold, the user sends the shown point information together with identification information of the user to a center apparatus, the center apparatus stores and manages points corresponding to the sent point information in correspondence with the user, and a prescribed service is provided to the user according to the points stored and managed in correspondence with the user, wherein a point issue number which indicates the order of issue of the point information is added to the point information shown to the user; a point issuing device for issuing the point information stores a plurality of encryption keys and uses any of the plurality of encryption keys to encrypt the point information; and the center apparatus stores a plurality of decryption keys corresponding to the plurality of encryption keys and uses any of the decryption keys to decrypt the encrypted point information and accepts as genuine the encrypted point information, which is successfully decrypted.

The point issue number recurs and is reused from 1 when it reaches the maximum value, and the point issuing device changes the encryption key when the point issue number recurs.

The center apparatus stores the point issue number of the point information accepted as genuine last time and the decryption key having decrypted the point information accepted as genuine, when the stored point issue number is contained in a first prescribed range containing the maximum value of the point issue number and in a second prescribed range containing 1, uses at most two decryption keys containing the decryption key used to decrypt the point information last time; and when it is not contained in either of the first and second prescribed range, uses the decryption key previously used for decryption of the point information.

The present invention is a promotion system in which point information related to a prescribed point is issued and shown to a user when a commodity is sold, the user sends the shown point information together with identification information of the user to a center apparatus, the center apparatus stores and manages points corresponding to the sent point information in correspondence with the user, and a prescribed service is provided to the user according to the points stored and managed in correspondence with the user, comprising means for adding a point issue number, which indicates the order of issue of the point information, to the point information shown to the user; the center apparatus having means for storing the point issue number of the latest point information among the point information accepted as genuine by the last time, and means for storing whether the point issue numbers contained in a prescribed range having the point issue number of the stored latest point information at the center have been used or not by the last time.

The point issue number recurs and is reused from 1 when it reaches the maximum value.

The latest point information is point information which is the latest in order of issue or the latest in order of acceptance by the center apparatus.

When the point issue number of the stored latest point information is updated, the prescribed range is updated accordingly; and when the point issue number stored as a used one by the last time falls outside the prescribed range because of the update of the prescribed range, memory about the point issue number that it has been used by the last time is deleted.

The present invention is a promotion system in which point information related to a prescribed point is issued and shown to a user when a commodity is sold, the user sends the shown point information together with identification information of the user to a center apparatus, the center apparatus stores and manages points corresponding to the sent point information in correspondence with the user, and a prescribed service is provided to the user according to the points stored and managed in correspondence with the user, wherein a point issue number which indicates the order of issue of the point information is added to the point information shown to the user; a point issuing device for issuing the point information has means for storing a plurality of encryption keys and encrypting the point information using any of the plurality of encryption keys; and the center apparatus has means for storing a plurality of decryption keys corresponding to the plurality of encryption keys and decrypting the encrypted point information using any of the decryption keys.

The point issue number recurs and is reused from 1 when it reaches the maximum value, and the point issuing device changes the encryption key for encrypting the point information when the point issue number recurs.

### BRIEF DESCRIPTION OF THE DRAWINGS

FIG. 1 is a system structure diagram showing an example of the structure of a promotion system according to the present invention;

FIG. 2 is a diagram for illustrating point information in the promotion system shown in FIG. 1;

FIGS. 3(a) and 3(b) are diagrams for illustrating an example of a method for judging unauthorized use of point information; and

FIG. 4 is a diagram for illustrating another example of the method for judging unauthorized use of point information.

### BEST MODE FOR CARRYING OUT THE INVENTION

Embodiments of a method for managing the promotion system to which the present invention pertains will be described in detail with reference to the accompanying drawings.

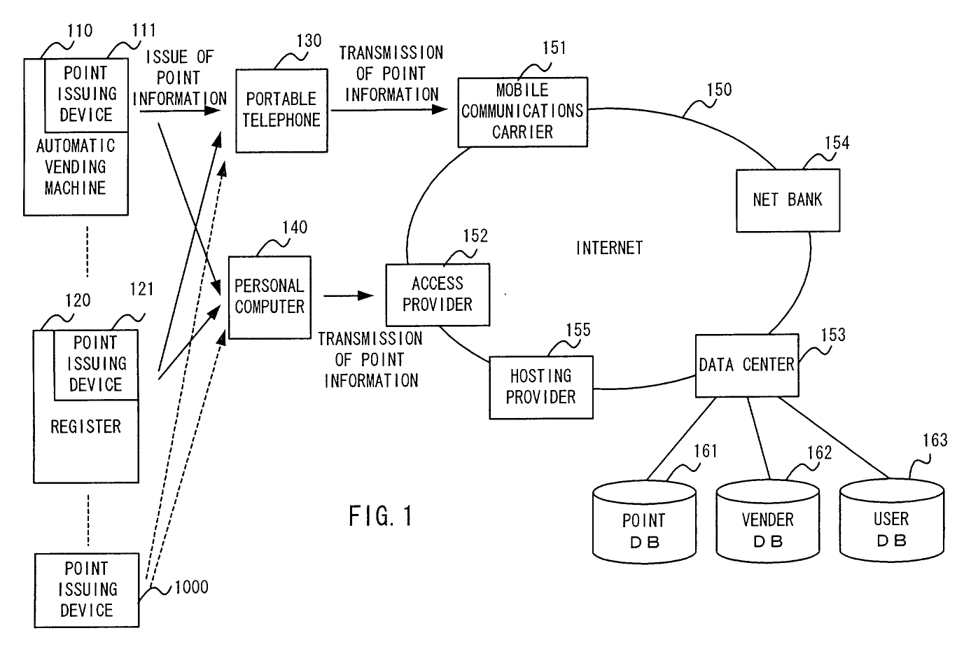

FIG. 1 is a system structure diagram showing an example of the structure of the promotion system according to the present invention.

In FIG. 1, this promotion system is used to issue points for commodities to be sold by a plurality of automatic vending machines 110 which are disposed outdoors or indoors and a register 120 which is disposed in various stores and shops.

Specifically, this promotion system enables sales promotion of commodities sold by the automatic vending machines 110 and sales promotion of various kinds of commodities in the shops and stores where the register 120 is disposed.

A point issuing device 111 of the automatic vending machine 110 generates point information corresponding to the selling price, sold quantity, etc. of the sold commodity every time the commodity is sold by the automatic vending machine 110 and shows the point information on a display section (not shown) mounted on the point issuing device 111.

A point issuing device 121 of the register 120 also generates point information corresponding to its selling price, sold quantity, etc. every time the register 120 makes sales and shows the point information on a display device (not shown) mounted on the point issuing device 121.

An independent point issuing device 1000 also generates point information corresponding to the selling price, sold quantity, etc. every time prescribed sales are made and shows the point information on a display section (not shown) mounted on the point issuing device 1000.

The point information includes:

1) a module code, and

2) a secret code.

Here, the module code identifies the above point issuing devices 111, 121 or the like and the promotion system is configured for storage management of the states of the automatic vending machine 110 and the register 120 according to the module code by a vender database (vender DB) 162 of a data center 153.

And, the secret code includes:

1) point issue number,

2) number of points,

3) parity, etc.

Here, the point issue number is a serial number to be issued every time a point is issued by the point issuing devices 111, 121 or the like and used to check double use and unauthorized use of the point information.

The number of points is a number of points obtained by the user for every sales, and the parity is additional information for checking that the point information being transmitted by the user does not have an error or interpolation during the transportation including encrypting and decrypting processes.

The secret code is generated by encrypting such information by a previously stored encryption key.

The user of the promotion system reads to store the point information shown on the display sections of the point issuing devices 111 and 121, inputs the stored point information to a portable telephone 130 or a personal computer (hereinafter called a PC) 140, and sends it together with an ID (identification information) for identification of the user and a prescribed password to the data center 153.

The point issuing devices 111, 121 may have a built-in infrared communications device, which is used to input the point information to the portable telephone 130 or the like.

The point issuing devices 111, 121 may be provided with means for printing and outputting the point information.

The point issuing device 121 of the register 120 may be configured to print and output the point information generated by the point issuing device 121 on a receipt printed and output from the register 120.

The data center 153 is configured as a Web server on the Internet 150 and provided with a point database (point DB) 161 which stores and manages the points obtained by the user in association with the user ID, the vendor database (vendor DB) 162 which stores and manages the states and the like of the automatic vending machine 110 and the register 120 according to the module code, and a user database (user DB) 163 which stores and manages the individual information of the user.

Transmission of point information to the data center 153 via the portable telephone 130 carried by the user is performed via the portable telephone 130, a mobile telecommunications carrier 151 and the Internet 150.

Transmission of the point information from the PC 140 of the user to the data center 153 is made via the PC 140, an access provider 152 of the user and the Internet 150.

Upon receiving the point information from the portable telephone 130 or the PC 140 of the user, the data center 153 refers to the user database 163 to check the user ID and password.

Then, a module code is checked with reference to the vendor database 162.

The secret code is then decrypted, the parity is checked, the point issue number is checked, and the number of points is checked. According to the checked results, the point database 161 is updated.

The data center 153 performs:

1) management of the user according to the registration and update of the user database 163;

2) management of points according to the point database 161;

3) management of the point issuing device according to the registration and update of the vendor database 162;

4) management of various lotteries and winners according to the points stored in the point database 161;

5) provision of marketing information to the administrator of the automatic vending machines 110 and the shops and stores where the register 120 is disposed; and

6) management of sales information, commodities, change, trouble and the like of the automatic vending machines 110.

On the Internet 150, there are a net bank 154 for executing the settlement for the data center 153 on the above points, a hosting provider 155 for delivering home pages to provide marketing information to the administrator of the automatic vending machines 110 and the shops and stores where the register 120 is disposed for the data center 153, and the like.

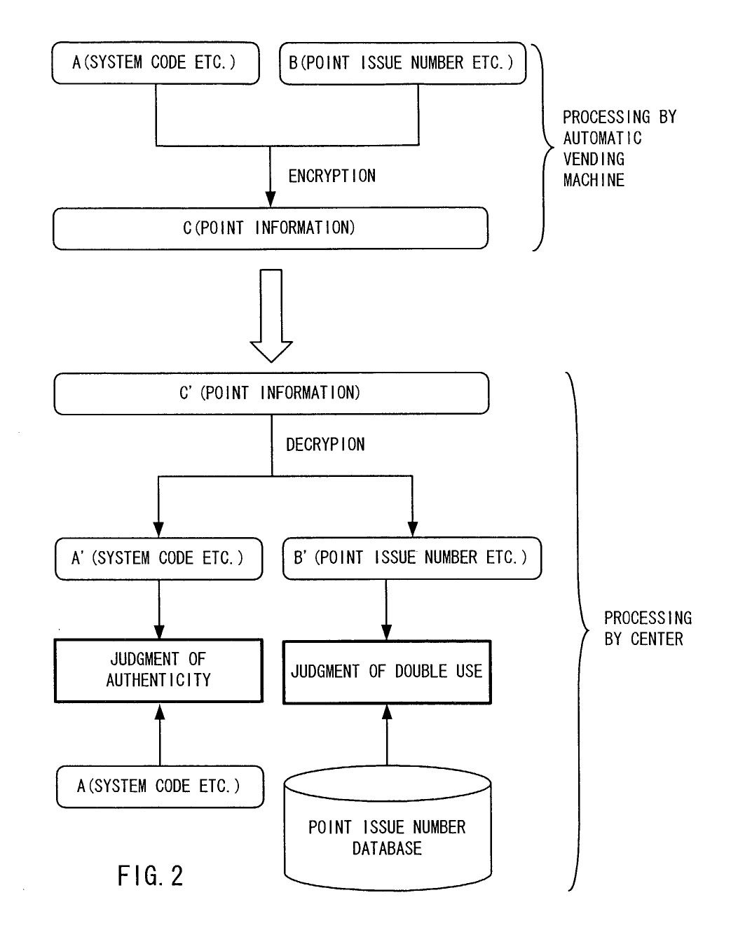

For example, the point information to be generated by the point issuing device 111 and the point issuing device 121 is generated by the method shown in FIG. 2.

Specifically, the point issuing device 111 and the point issuing device 121 encrypt information (promotion system code, etc.) A inherent in the promotion system and information (point issue number etc.) B inherent in the issued point according to a prescribed encryption key, generate point information C and visually show it on an unshown point information display section as shown in FIG. 2.

A buyer sends the shown point information C to the data center 153 by the portable telephone 130 or the PC 140.

The data center 153 which has received point information C′ (if genuine, same as the point information C) uses a prescribed decryption key to obtain information A∝ and information B′.

Then, the information A′ is compared with the information (system code etc.) A inherent in the promotion system previously stored in the data center 153 to check whether the point information is genuine or not (authenticity judgment).

Beside, the information B′ is retrieved from the point issue number database managed by the data center 153 to check whether it is unused or not (double use judgment).

Authenticity of the point information and double use judgment will be described in detail below.

### EXAMPLE 1

In this example, among the point issue numbers of the point information accepted as genuine by the last time, the point issue number database stores the latest point issue number in the issued order as the latest genuine point issue number, and when the point issue number of the point information sent from the user is included in a prescribed range having the stored latest genuine point issue number as the center value, judges that the point information sent by the user is effective and makes the double use judgment, and judges that point information having another issue number is ineffective and processes it as illegal use.

It is a method based on a concept that the user having obtained the point information will not take such a long time to send the point information to the center apparatus, and the point issue numbers of point information to be sent before and after that will have a similar value at a considerably high probability.

The latest genuine point issue number to be stored by the center apparatus may be the latest one in order of reception by the center apparatus in addition to the above latest one in order of issuance.

Therefore, the point issue number database does not need to store all the used point issue numbers but may store only the used point issue numbers contained in the prescribed range having the latest genuine point issue number as the center value. Therefore, all the point information having point issue numbers outside the prescribed range is handled as ineffective, and the point issue numbers outside the prescribed range can be reused.

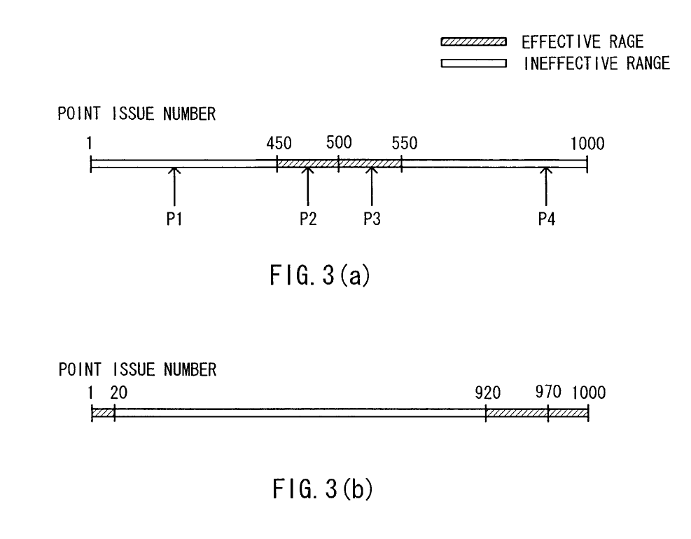

For example, as shown in FIG. 3(a), when it is assumed that the maximum value of the point issue number is 1000, the point issue number, which is accepted as genuine by the last time and the latest in order of issue, is 500, and the point number of the point information sent from the user is a point issue number contained in 50 before and after the point number 500 falling in a range of 100 in total, namely a point issue number in a range of 450 to 550 (P2 and P3), this point information is judged as effective, and point information (P1 and P4) having other point issue numbers are judged as ineffective and processed as illegal use.

Besides, considering that point issue numbers 501 to 550 are naturally unused, the point issue number database stores only those included in a range of 450 to 499 among the used point issue numbers and, when the point issue number of the point information sent from the user is included in the point issue numbers 450 to 499 (P2), compares the point issue number P2 with the point issue numbers stored as the used one to judge whether it is unused (double use judgment).

When the latest genuine point issue number is updated from 500 to 502, the range of effective point issue number is also shifted and updated to cover 452 to 552, and information on whether used or not stored in connection with 450 and 451 is deleted.

The point issue number is reissued from 1 after it is issued up to the maximum value. Therefore, for example, when the latest genuine point issue number is 970, the point issue number included in a total range of 100 consisting of 80 between the point issue numbers 920 and 1000 and the point issue numbers 1 to 20 after the cycle is handled as an effective point issue number as shown in FIG. 3(b).

According to the above method, even when the point issue number reaches 1000 and the point issue number 1 is already used, a used label of the point issue number 1 is updated after it becomes ineffective once, and 1 can be reissued after 1000, and the point issue number can be used in recurrence.

The maximum value of the point issue number, the range of the effective point issue number and the method for updating the range are not limited to those described above but can be determined as desired.

### EXAMPLE 2

In this example, a plurality of encryption keys are provided for the point issuing device, and a plurality of decryption keys corresponding to the encryption keys are provided in the center apparatus. The point issuing device encrypts the point information issued by means of any of the provided encryption keys, and the center apparatus decrypts the encrypted point information sent from the user by means of any of the provided decryption keys.

When the issued point issue number becomes the maximum value, it recurs to 1 again and is reused, and the point issuing device then changes the encryption key for encrypting the point information.

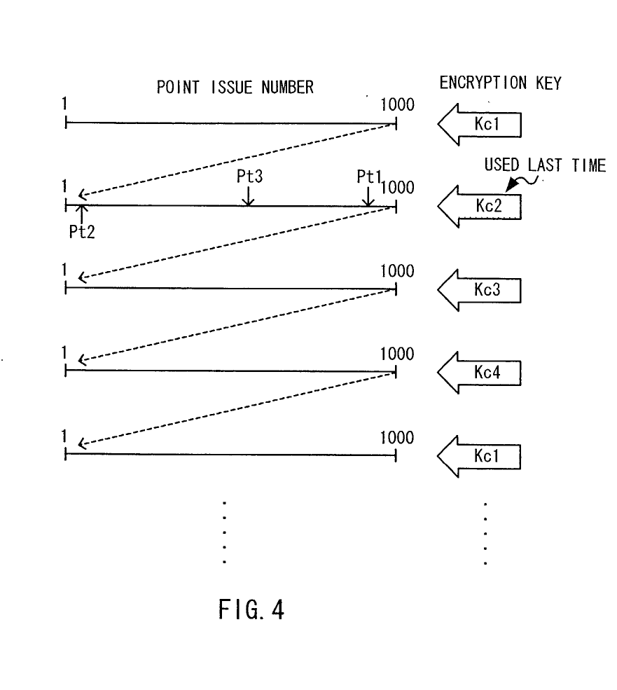

For example, the point issuing device has four encryption keys Kc1 to Kc4 and changes the encryption keys sequentially every time the point issue number becomes the maximum value 1000 as shown in FIG. 4. It is changed in order of Kc1, Kc2, Kc3 and Kc4 in FIG. 4.

The center apparatus decrypts the encrypted point information sent from the user by means of decryption keys Kr1 to Kr4 corresponding to the encryption keys Kc1 to Kc4.

The center apparatus can try all the decryption keys to decrypt the encrypted point information sent from the user. But, here, a method which stores the point issue number of the point information accepted as genuine last time and the decryption key (Kr2) used to decrypt the point information last time and selectively uses the decryption key according to the stored information will be described.

First, when the point issue number (Pt1) of the point information accepted as genuine last time is a number in a prescribed range containing 1000 of the point issue number 1000 or less, the point information sent from the user has a point issue number which is in proximity of 1000 and is encrypted by the encryption key Kc2 or recurs to have a point issue number which is in proximity of 1 and encrypted, so that the center apparatus uses the decryption key Kr2 used last time and the decryption key Kr3 which is next to the decryption key Kr2 in terms of the order corresponding to the encryption key used by the point issuing device and decrypts the encrypted point information sent from the user.

When the point issue number (Pt2) of the point information accepted as genuine last time is a number in a prescribed range containing 1 of the point issue number 1 or more, the point information sent from the user may have a point issue number which is in proximity of 1 and be encrypted by the encryption key Kc2 or may have a point issue number which is in proximity of the point issue number 1000 before the circulation and be encrypted by the encryption key Kc1. Therefore, the center apparatus uses the decryption key Kr2 used last time and the decryption key Kr3 which is prior to the decryption key Kr2 in terms of the order corresponding to the encryption key used by the point issuing device to decrypt the encrypted point information sent from the user.

When the point issue number (Pt3) of the point information accepted as genuine last time is a number not in either of the above prescribed ranges, the center apparatus uses only the decryption key Kr2 used last time to decrypt the encrypted point information sent from the user.

And, only the point information decrypted by the above method is checked whether it is unused (double use judgment) and accepted as genuine if it is unused.

### INDUSTRIAL APPLICABILITY

The present invention is a method for judging unauthorized use of point information and a promotion system, which is configured to store whether only a number in a prescribed range of the entire point issue numbers has been used or not. According to the invention, a number not contained in a prescribed range of the entire point issue numbers can be reused, and the point issue number can be used effectively. And, a double use check time can be reduced because only a prescribed range is checked.

1. A method for judging unauthorized use of points of a promotion system in which point information related to a prescribed point is issued and shown to a user when a commodity is sold, the user sends the shown point information together with identification information of the user to a center apparatus, the center apparatus stores and manages points corresponding to the sent point information in correspondence with the user, and a prescribed service is provided to the user according to the points stored and managed in correspondence with the user, wherein:
a point issue number which indicates the order of issue of the point information is added to the point information shown to the user;
the center apparatus:
stores the point issue number of the latest point information among the point information accepted as genuine by the last time, and
stores whether the point issue numbers contained in a prescribed range having the point issue number of the stored latest point information at the center have been used or not by the last time, and
the point issue number sent from the user is accepted as genuine when the point issue number of the point information sent from the user does not match the point issue number which is contained in the prescribed range and stored as a used one by the last time.

2. The method for judging unauthorized use of point information according to claim 1, wherein the point issue number recurs and is reused from 1 when it reaches the maximum value.

3. The method for judging unauthorized use of point information according to claim 1, wherein the latest point information is point information which is the latest in order of issue.

4. The method for judging unauthorized use of point information according to claim 1, wherein the latest point information is point information which is the latest in order of acceptance by the center apparatus.

5. The method for judging unauthorized use of point information according to claim 1, wherein:
when the point issue number of the stored latest point information is updated, the prescribed range is updated accordingly, and
when the point issue number stored as a used one by the last time falls outside the prescribed range because of the update of the prescribed range, memory about the point issue number that it has been used by the last time is deleted.

6. A method for judging unauthorized use of point information of a promotion system in which point information related to a prescribed point is issued and shown to a user when a commodity is sold, the user sends the shown point information together with identification information of the user to a center apparatus, the center apparatus stores and manages points corresponding to the sent point information in correspondence with the user, and a prescribed service is provided to the user according to the points stored and managed in correspondence with the user, wherein:
a point issue number which indicates the order of issue of the point information is added to the point information shown to the user;
a point issuing device for issuing the point information stores a plurality of encryption keys and uses any of the plurality of encryption keys to encrypt the point information; and
the center apparatus:
stores a plurality of decryption keys corresponding to the plurality of encryption keys and uses any of the decryption keys to decrypt the encrypted point information; and
accepts as genuine the encrypted point information, which is successfully decrypted.

7. The method for judging unauthorized use of point information according to claim 6, wherein the point issue number recurs and is reused from 1 when it reaches the maximum value, and the point issuing device changes the encryption key for encrypting the point information when the point issue number recurs.

8. The method for judging unauthorized use of point information according to claim 7, wherein:
the center apparatus:
stores the point issue number of the point information accepted as genuine last time and the decryption key having decrypted the point information accepted as genuine,
when the stored point issue number is contained in a first prescribed range containing the maximum value of the point issue number and in a second prescribed range containing 1,
uses at most two decryption keys containing the decryption key used to decrypt the point information last time; and
when it is not contained in either of the first and second prescribed range,
uses the decryption key previously used for decryption of the point information.

9. A promotion system in which point information related to a prescribed point is issued and shown to a user when a commodity is sold, the user sends the shown point information together with identification information of the user to a center apparatus, the center apparatus stores and manages points corresponding to the sent point information in correspondence with the user, and a prescribed service is provided to the user according to the points stored and managed in correspondence with the user, comprising:
means for adding a point issue number, which indicates the order of issue of the point information, to the point information shown to the user;
the center apparatus having:
means for storing the point issue number of the latest point information among the point information accepted as genuine by the last time, and
means for storing whether the point issue numbers contained in a prescribed range having the point issue number of the stored latest point information at the center have been used or not by the last time.

10. The promotion system according to claim 9, wherein the point issue number recurs and is reused from 1 when it reaches the maximum value.

11. The promotion system according to claim 9, wherein the latest point information is point information which is the latest in order of issue.

12. The promotion system according to claim 9, wherein the latest point information is point information which is the latest in order of acceptance by the center apparatus.

13. The promotion system according to claim 9, wherein:
when the point issue number of the stored latest point information is updated, the prescribed range is updated accordingly; and
when the point issue number stored as a used one by the last time falls outside the prescribed range because of the update of the prescribed range, memory about the point issue number that it has been used by the last time is deleted.

14. A promotion system in which point information related to a prescribed point is issued and shown to a user when a commodity is sold, the user sends the shown point information together with identification information of the user to a center apparatus, the center apparatus stores and manages points corresponding to the sent point information in correspondence with the user, and a prescribed service is provided to the user according to the points stored and managed in correspondence with the user, wherein:
a point issue number which indicates the order of issue of the point information is added to the point information shown to the user;
a point issuing device for issuing the point information has means for storing a plurality of encryption keys and encrypting the point information using any of the plurality of encryption keys;
the center apparatus has:
means for storing a plurality of decryption keys corresponding to the plurality of encryption keys and decrypting the encrypted point information using any of the decryption keys.

15. The promotion system according to claim 14, wherein:
the point issue number recurs and is reused from 1 when it reaches the maximum value, and
the point issuing device changes the encryption key for encrypting the point information when the point issue number recurs.
